(19) United States
(12) Patent Application Publication
(10) Pub. No.: US 2011/0162930 A1
(43) Pub. Date: Jul. 7, 2011

(54) Means for Isolating Rotational Vibration to Sensor

(75) Inventors: David Blair, Western Australia (AU); Ju Li, Western Australia (AU); Howard Golden, Western Australia (AU)

(73) Assignee: The University fo Western Australia

(21) Appl. No.: 12/993,818

(22) PCT Filed: May 21, 2009
(86) PCT No.: PCT/AU2009/000636

§ 371 Date: Feb. 7, 2011

(30) Foreign Application Priority Data
May 21, 2008 (AU) 2008902551

(51) Int. Cl. F16F 7/10; F16F 9/10

(52) U.S. Cl. 188/378; 188/266

(57) ABSTRACT

A rotational vibration isolator for a sensor is disclosed. The isolator comprises a first enclosure surrounding the sensor and a second enclosure surrounding the first enclosure, with a spherical gap between the enclosures. A fluid is supplied into this gap, the density of the fluid being sufficient to support the first enclosure in a condition of neutral buoyancy. The first and second enclosures are connected by springs of low spring constant.

### FIELD OF THE INVENTION

The present invention relates to means for isolating devices, such as sensing devices, from rotational vibration. It finds particular application in isolating airborne electromagnetic sensors from rotational vibration.

### BACKGROUND TO THE INVENTION

Certain geophysical properties of the earth can be detected using airborne surveying equipment. Commonly, such equipment is used to map electrically conductive ore bodies such as massive nickel sulphide. The presence of conductive ore causes a localised distortion in the earth's electrical impedance.

This distortion can be detected by sensing equipment towed behind an aircraft, arranged to determine the earth's response to electromagnetic pulses transmitted with a certain frequency from the aircraft.

In practice, one of the limitations of such sensing equipment is its susceptibility to rotational vibration. As the earth's localised magnetic field is generally uni-directional, rotation of a sensor within this field can produce significant variation in measured field strength and direction. When the sensor is being towed behind an aircraft, changes in altitude or direction of the aircraft or even changes in cross-winds can cause rotational vibration of the sensor, thus inducing significant error and limiting the sensors ability to produce useful results.

The problems of rotational vibration are particularly acute in relation to measurements conducted at low transmitter frequencies, often associated with deeper ore bodies.

The present invention seeks to provide means for at least partially isolating sensing equipment from rotational vibration.

### SUMMARY OF THE INVENTION

In accordance with a first aspect of the present invention there is provided a rotational vibration isolator for a sensor, the isolator comprising a first enclosure surrounding the sensor and a second enclosure surrounding the first enclosure, the second enclosure being connected to the first enclosure by at least one resilient member, a space between the first and second enclosures being filled with a fluid, wherein the density of the fluid is sufficient to support the first enclosure in a condition of neutral buoyancy.

In accordance with a second aspect of the present invention there is provided a method for isolating rotational vibration of a sensor, the method for isolating rotational vibration comprising locating the sensor within a first enclosure, locating the first enclosure within a second enclosure, connecting the second enclosure to the first enclosure by at least one resilient member, and filling a space between the first and second enclosures with a fluid, wherein the density of the fluid is sufficient to support the first enclosure in a condition of neutral buoyancy.

Such an arrangement permits the fluid to act as damped gimbals restricting the transfer of vibration, particularly rotational vibration, from the second enclosure to the first enclosure and thus the sensor.

The fluid may be a liquid, such as water or oil. Where the sensor is an electromagnetic sensor, the fluid should not be electrically conductive.

In order to achieve neutral buoyancy, the mass of the first enclosure, together with its contents, must be equal to the mass of the fluid which would be displaced by the first enclosure. In order to achieve this mass, it may be necessary to include additional masses within the first enclosure. The additional masses are preferably formed from a high-density material, such as one with density above 10 g.cm³. In one preferred form of the invention, the additional masses are formed from tantalum, tungsten or lead.

In a preferred form of the invention both the first enclosure and the second enclosure are substantially spherical, with the second enclosure having an inner radius about 10% larger than the outer radius of the first enclosure.

Preferably, the first enclosure includes a plurality of additional masses. This may comprise at least one, preferably two, additional masses associated with each of three orthogonal axes of the first enclosure.

The location of each mass, such as its radial distance from the centre of the first enclosure, may be adjustable by adjustment means. Preferably, the adjustment means can be controlled from outside the second enclosure. In an embodiment of the invention, this is achieved by mounting the additional masses on screw threads which can be rotated from outside the second enclosure.

Preferably, the first and second enclosures are connected by a plurality of resilient members, such as springs having low spring coefficients. The resilient members are arranged so as to permit relatively large, sudden movements of the second enclosure relative to the first enclosure without failing, and to relatively slowly bring the first enclosure back into alignment with the second enclosure following such a movement.

Preferably, the second enclosure has means available to readily access the fluid within, in order to add fluid or remove fluid as may be required.

The density of the fluid may be adjusted or fine tuned by adding soluble substances such as sugar. Appropriate soluble substances will not cause the fluid to become electrically conductive or magnetic. The fluid used, together with any soluble additions, should not be chemically reactive with either the first or the second enclosure.

### BRIEF DESCRIPTION OF THE DRAWINGS

It will be convenient to further describe the invention with reference to preferred embodiments of the isolation means of the present invention. Other embodiments are possible, and consequently, the particularity of the following discussion is not to be understood as superseding the generality of the preceding description of the invention. In the drawings:

FIG. 1 is a general conceptual cross sectional representation of the rotational vibration isolator of the present invention;

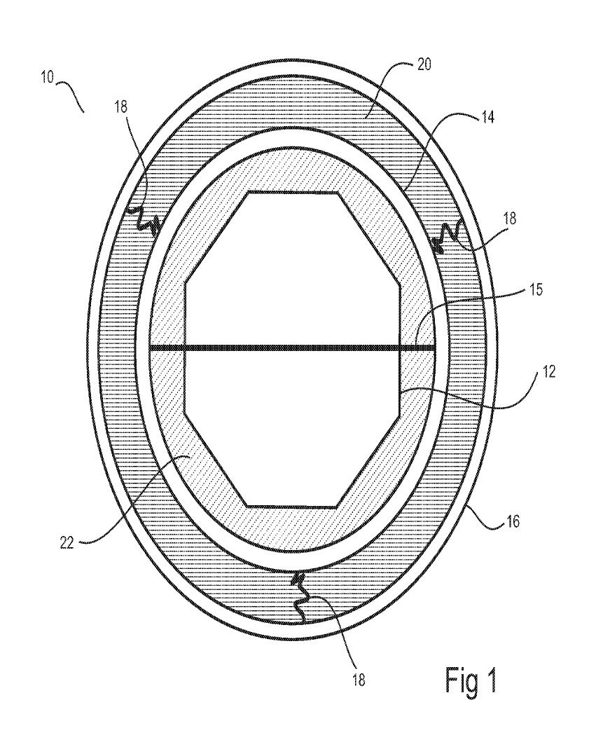

FIG. 2 is a general conceptual cross sectional representation of a first enclosure within the rotational vibration isolator of FIG. 1;

FIG. 3 is a general conceptual cross sectional representation of a second enclosure surrounding the first enclosure of FIG. 2; and

FIG. 4 is a cross sectional view of an adjustable mass within the first enclosure of FIG. 2.

### DESCRIPTION OF PREFERRED EMBODIMENT

Referring to the drawings, there is shown a rotation vibration isolator 10 arranged to encase a sensor 12, such as an airborne electromagnetic sensor. The sensor 12 is supported within a first enclosure 14, for instance by relatively rigid springs 15. The first enclosure 14 is in turn encased in a second enclosure 16, and is connected to the second enclosure 16 by a plurality of resilient members, being springs 18. The first and second enclosures 14, 16 are both substantially spherical and concentric, with the first enclosure 14 having an external radius which is less than an internal radius of the second enclosure 16. The resulting spherical gap 20 between the first enclosure 14 and the second enclosure 16 is filled with a supporting fluid 22, which in this embodiment is a liquid such as oil or water.

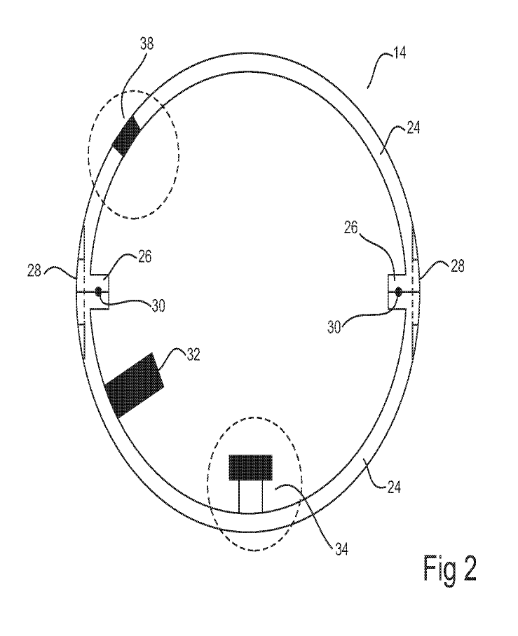

The first enclosure 14 is shown in more detail in FIG. 2. The first enclosure 14 is formed from two hemispheres 24, mounted together using internal flanges 26. The respective internal flanges 26 are arranged to be bolted together from outside the first enclosure 14, using bolt holes 28. The internal flanges include a resilient seal, such as an O-ring seal 30, to prevent the ingress of fluid into the first enclosure 14. It will be appreciated that the use of internal flanges permits an outer surface of the first enclosure 14 to be substantially spherical.

The first enclosure 14 has a sensor (not shown) mounted within it. It also has a primary mass 32 and a plurality of adjustable masses 34 located about its inner surface.

The primary mass 32 is made of a suitably dense material. It is envisaged that a material with density in excess of 10 g.cm⁻³, and preferable in excess of 15 g.cm⁻³, will be particularly useful. The embodiment of the drawings proposes tantalum, although other dense materials such as tungsten or lead may be used. The mass of the primary mass 32 is sufficient to bring the total mass of the first enclosure 14, and everything contained within it, close to its desired mass as will be discussed below.

The adjustable masses 34 are preferably located at respective ends of three orthogonal axes of the first enclosure 14, with a total of six adjustable masses 34 being provided. The sum of the adjustable masses is chosen, together with the primary mass 32, to bring the first enclosure 14 to exactly its desired mass.

The adjustable masses 34 are mounted on threaded shafts, as will be described below.

The first enclosure also includes an electrical through-point 38. The electrical through point 38 is arranged to allow the transfer of electrical power into the first enclosure 14 and thus the sensor 12, and to allow the transfer of signals from the sensor 12 through the first enclosure 14. The electrical through point 38 is sealed to prevent the ingress of fluid.

The first enclosure 14 is preferably formed from an acrylic material, although other suitable materials such as suitable plastics may be used.

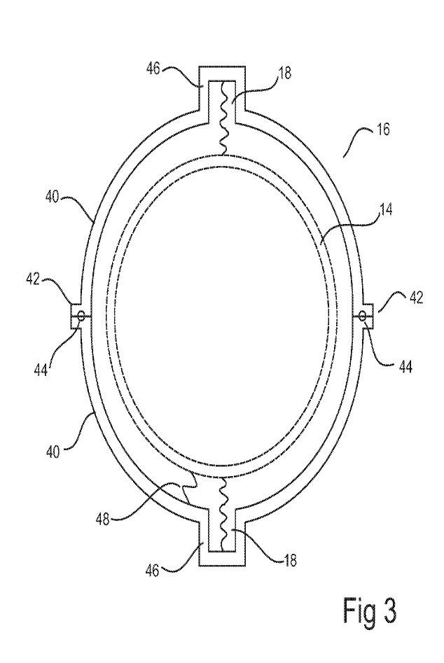

The second enclosure 16 is shown in greater detail in FIG. 3. this enclosure is constructed from two flanged hemispheres 40, in a similar fashion to the first enclosure 14. In contrast to the first enclosure 14, the flanges 42 of the second enclosure 16 are located externally. This is to prevent protrusions from internal surface of the second enclosure 16. The flanges 42 are arranged to be bolted together, and sealed by an O-ring 44.

The second enclosure 16 includes a plurality of mounting points 46 for springs 18. Each mounting point 46 is recessed from the internal surface of the second enclosure 14, and thus protrudes outwardly from the external surface of the second enclosure 14.

Each spring 18 extends from a mounting point 46 to the first enclosure 14. The arrangement is such that when each spring 18 is in a neutral position, the first enclosure 14 is exactly centered within the second enclosure 16.

The second enclosure 16 includes a sealable filling point (not shown) through which fluid can be introduced. It also includes an electrical connection 48 which can communicate with the sensor 12 via the electrical through point 38.

In use, a suitable fluid 22 is chose. Possible fluids include water, oil and anti-freeze. It is envisaged that a suitable fluid will be one which exhibits no electrical conduction and no magnetism, does not corrode or dissolve either the first or second enclosure, and has appropriate physical properties at the environmental conditions likely to be experienced. Once the fluid 22 has been selected, a calculation may be made as to the mass of this fluid (measured at the density the fluid is likely to exhibit in use, which may be at altitude) which would be displaced by the first enclosure.

In order for the first enclosure to achieve neutral buoyancy, its mass must be adjusted to equal the calculated displaced mass of fluid. This is achieved by supplying a primary mass 32 and adjustable masses 34 of appropriate size. Fine tuning may be achieved by adjusting the density of the fluid, for example by adding sugar or other suitable soluble material.

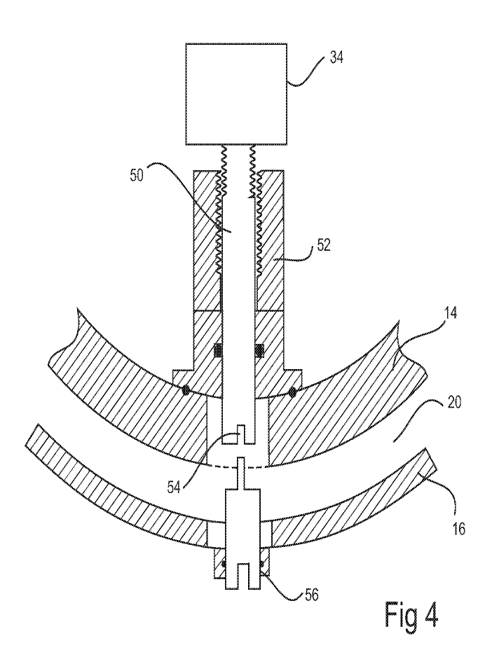

It will also be necessary to trim the weight distribution within the first enclosure 14 to negate any tendency to rotate due to misaligned weights. This is done by manipulation of the radial distance of the adjustable masses 34, using a mechanism shown in FIG. 4.

Each adjustable mass 34 is located on a threaded shaft 50. The threaded shaft 50 is mounted within an internally threaded sleeve 52. The arrangement is such that rotation of the shaft 50 within the sleeve 52 causes longitudinal movement of the adjustable mass 34 along a radius of the first enclosure 14.

An outer end of the threaded shaft 50, remote from the adjustable mass 34, is provided with a slot 54 or other engaging means.

At an aligned location, the second enclosure 16 is provided with a flexible turning mechanism 56. The turning mechanism 56 is arranged such that, upon the supply of a small axial force, applied from outside the second enclosure 16, the turning mechanism 56 will extend through the gap 20 and engage with the slot 54. Rotation of the turning mechanism 56 from outside the second enclosure 16 will then cause rotation of the shaft 50, and thus radial movement of the adjustable mass 34.

The adjustable masses 34 can be adjusted to ensure that the centre of mass of the first enclosure is centrally located.

In use, the second enclosure 16 may be towed behind an aircraft. Any sudden change in direction of the aircraft, or other external force, may cause a sudden movement of the second enclosure 16. The presence of the fluid 22, however, dramatically dampens the associated movement of the first enclosure 14 and sensor 12. The presence of the springs 18, chosen to have a low spring coefficient and to have a high degree of elasticity, will cause the first enclosure 14 to slowly re-align with the second enclosure 16.

When the second enclosure 16 is subject to vibration, the fluid will largely dampen this vibration so as to not affect the sensor 12.

In the embodiment of the drawings, the second enclosure 16 has an external diameter of about 400 mm, with an internal diameter of about 340 mm.

The first enclosure has an external diameter of about 300 mm. This means that about 5 litres of fluid is required.

Modifications and variations as would be apparent to a skilled addressee are deemed to be within the scope of the present invention.

1. A rotational vibration isolator for a sensor, the isolator comprising a first enclosure surrounding the sensor and a second enclosure surrounding the first enclosure, the second enclosure being connected to the first enclosure by a least one resilient member, a space between the first and second enclosures being filled with a fluid, wherein the density of the fluid is sufficient to support the first enclosure in a condition of neutral buoyancy.

2. A rotational vibration isolator as claimed in claim 1, wherein the fluid is a liquid.

3. A rotational vibration isolator as claimed in claim 2, wherein the fluid is water or oil.

4. A rotational vibration isolator as claimed in claim 2, wherein the fluid includes a dissolved substance to achieve a desired density.

5. A rotational vibration isolator as claimed in claim 1, wherein additional masses are included within the first enclosure to achieve neutral buoyancy.

6. A rotational vibration isolator as claimed in claim 5, wherein the additional masses are formed from a material with density above 10 g.cm⁻³.

7. A rotational vibration isolator as claimed in claim 5, wherein the first enclosure includes a plurality of additional masses.

8. A rotational vibration isolator as claimed in claim 7, wherein the additional masses include at least one additional masses associated with each of three orthogonal axes of the first enclosure.

9. A rotational vibration isolator as claimed in claim 8, wherein the location of each mass is adjustable by adjustment means.

10. A rotational vibration isolator as claimed in claim 9, wherein the adjustment means can be controlled from outside the second enclosure.

11. A rotational vibration isolator as claimed in claim 1, wherein both the first enclosure and the second enclosure are substantially spherical.

12. A rotational vibration isolator as claimed in claim 11, wherein the second enclosure has an inner radius about 10% larger than an outer radius of the first enclosure.

13. A rotational vibration isolator as claimed in claim 1, wherein the first and second enclosures are connected by a plurality of resilient members.

14. A method for isolating rotational vibration of a sensor, the method for isolating rotational vibration comprising locating the sensing means within a first enclosure, locating the first enclosure within a second enclosure, connecting the second enclosure to the first enclosure by at least one resilient member and filling a space between the first and second enclosures with a fluid, wherein the density of the fluid is sufficient to support the first enclosure in a condition of neutral buoyancy.

15. A method for isolating rotational vibration as claimed in claim 14, including the further step of adding additional masses to the first enclosure to achieve neutral buoyancy.

16. A method for isolating rotational vibration as claimed in claim 15, including the further step of adjusting the position of the additional masses such that the centre of mass of the first enclosure is located centrally.

17. A method for isolating rotational vibration as claimed in claim 14, further including the step of adjusting the density of the fluid by adding soluble matter to it.
